(19) United States
(12) Patent Application Publication
(10) Pub. No.: US 2020/0018719 A1
(43) Pub. Date: Jan. 16, 2020

(54) GAS SENSOR, GAS SENSOR SYSTEM, AND METHOD OF MAKING AND USING A GAS SENSOR AND GAS SENSOR SYSTEM

(71) Applicant: KING ABDULLAH UNIVERSITY OF SCIENCE AND TECHNOLOGY, Thuwal (SA)

(72) Inventors: Himanshu MISHRA, Thuwal (SA); Navaladian SUBRAMANIAN, Thuwal (SA)

(21) Appl. No.: 16/491,011

(22) PCT Filed: Nov. 29, 2017
(86) PCT No.: PCT/IB2017/057502

§ 371 Date: Sep. 4, 2019

Related U.S. Application Data
(60) Provisional application No. 62/469,202, filed on Mar. 9, 2017.

(51) Int. Cl. G01N 27/416; G01N 27/404

(52) U.S. Cl. CPC G01N 27/4162; G01N 27/4045; G01N 27/4167

(57) ABSTRACT

A sensor system includes a vessel and a first electrode arranged on an exterior of the vessel. The first electrode, which includes iridium oxide, is electrochemically formed on an adhesive layer which is arranged on the exterior of the vessel. An electrolyte is arranged within the vessel. A second electrode is in contact with the electrolyte in the vessel. An opening is at a bottom of the vessel. The opening is configured to allow the electrolyte to contact the second electrode.

### CROSS-REFERENCE TO RELATED APPLICATIONS

This application is a continuation of, and claims priority from, U.S. Provisional Patent Application No. 62/469,202, filed on Mar. 9, 2017, entitled “IRIDIUM OXIDE MICROELECTRODES FOR SENSING MOISTURE AND HUMID FUMES OF ACIDS AND BASES”, the disclosure of which is incorporated here by reference.

### BACKGROUND

### Technical Field

Embodiments of the subject matter disclosed herein generally relate to a system and apparatus for detecting the presence of a gas, methods of producing the apparatus and system, and methods of using the apparatus and system.

### Discussion of the Background

Detecting the presence of a particular gas or of particular acids or bases in a liquid is typically performed based on measured pH levels. One conventional technique for such detection involves the use of capacitive sensors, which suffer from particularly long response times of at least twenty seconds. Depending on the application and the nature of gas being detected, this long response time may be insufficient for warning of the presence of a dangerous gas.

Other techniques are limited to detecting the presence of either a particular gas or particular acids or bases in a liquid. Additional limitations of conventional techniques include low sensitivity over a wide range of water content and temperature, are expensive and complicated to produce, and may provide a non-linear response.

Thus, there is a need for methods and apparatus that can detect the presence of a particular gas or particular acids or bases in a liquid that provides fast response times, are sensitive over a range of water content and temperature, are inexpensive and relatively easy to produce, and provide a linear response.

### SUMMARY

According to an embodiment, there is a sensor system, which includes a vessel and a first electrode arranged on an exterior of the vessel. The first electrode comprises iridium oxide. An adhesive layer is arranged between the first electrode and the exterior of the vessel. An electrolyte is arranged within the vessel. A second electrode is in contact with the electrolyte in the vessel. An opening is at a bottom of the vessel. The opening is configured to allow the electrolyte to contact the second electrode.

According to another embodiment, there is a method for producing a sensor system. A conducting layer is deposited on an exterior of a vessel. A wire is connected to the conducting layer. An iridium oxide layer is formed on the conducting layer using potentiodynamic cycling between a positive and negative voltage. The iridium oxide layer is a first electrode. An interior of the vessel is filled with an electrolyte. A second electrode is inserted into the electrolyte inside the vessel and a top of the vessel is sealed.

According to yet another embodiment, there is a method of determining presence of a particular gas. A sensor is arranged in an environment. The sensor comprises a first electrode comprising iridium oxide and a second electrode comprising silver/silver chloride and the sensor does not directly contact a liquid from which the gas is produced. A gas is detected using a voltage produced by the sensor. The presence of the particular gas is determined in response to the voltage produced by the sensor falling within a predetermined voltage range.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a sensor for detecting the presence of particular gas or a particular acid or base in a liquid according to an embodiment;

FIG. 2 illustrates a sensor system for detecting the presence of particular gas or a particular acid or base in a liquid according to an embodiment;

FIG. 3 illustrates voltage response curve (open circuit potential) of the sensor as a response to acidic and neutral gas over 2 cycles according to an embodiment;

FIG. 4 illustrates a flowchart of a method for making a sensor system according to an embodiment;

FIG. 5 illustrates a scanning electron micrograph of a cross-section of the sensor according to an embodiment;

FIG. 6 illustrates cyclic voltammograms recorded during deposition of iridium oxide onto a gold surface according to an embodiment;

FIG. 7 illustrates a graph of an x-ray diffraction pattern of iridium oxide film on a gold/titanium/glass slide according to an embodiment;

FIG. 8A illustrates a top view scanning electrode microscope (SEM) image of an iridium oxide layer according to an embodiment;

FIG. 8B illustrates a cross-sectional transmission electron microscopic (TEM) image of an iridium oxide layer according to an embodiment;

FIG. 9 illustrates a cross-sectional SEM image of an iridium oxide layer according to an embodiment;

FIG. 10 illustrates an x-ray photoelectron spectroscopy of a gold/titanium/glass slide according to an embodiment;

FIG. 11 illustrates an infrared 4f spectrum of an iridium oxide film according to an embodiment;

FIG. 12 illustrates cyclic voltammograms of a gold/titanium/glass slide according to an embodiment;

FIG. 13 illustrates an open circuit potential (OCP) of a sensor for various gases according to an embodiment;

FIG. 14 illustrates a calibration plot of a sensor according to an embodiment;

FIG. 15 illustrates a flowchart of a method of using a sensor according to an embodiment; and

FIG. 16 illustrates a schematic diagram of a computer device that can be used to record data from the sensor according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a sensor and system for detecting the presence of a particular gas. However, the embodiments to be discussed next are not limited to gas detection, but may be applied to detection of the presence of acids or bases in a liquid.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment a sensor system includes vessel, a first electrode comprising iridium oxide formed on an exterior of the vessel, an adhesive layer arranged between the first electrode and the exterior of the glass capillary, an electrolyte arranged in the vessel, a second electrode arranged in contact with an electrolyte in the vessel, and an opening at a bottom of the vessel, the opening being configured to allow the electrolyte to contact the second electrode. Using an iridium oxide electrode is particularly advantageous due to its fast response time, chemical and temperature stability, sensitivity over a broad range of pH, and high durability. Although the pH sensing mechanisms of anhydrous iridium oxide coatings remain incompletely understood, the following chemical reactions describe the most common mechanisms of reduction of iridium oxide to iridium:

Ir₂O₃(s)+6H⁺(aq)+6e⁻(aq)↔2Ir(s)+3H₂O(aq) (1)

IrO₂(s)+4H⁺(aq)+4e⁻(aq)↔Ir(s)+2H₂O(aq) (2)

2IrO₂(s)+2H⁺(aq)+2e−(aq)↔Ir₂O₃(s)+H₂O(aq) (3)

In the case of hydrated oxides, a proposed mechanism is as follows:

2[Ir₂O(OH)₂₋ₓ(2+x)H₂O]^{(2-x)}(s)+(3−2x)H⁺(aq)+2e⁻(aq)↔[Ir₂O₃(OH)₃·3H₂O]³⁻(s)+3H₂O(aq) (4)

Typically, the sensitivity of pH electrodes is standardized by open circuit potentials generated when brought in contact with solutions of known pH. The measured electrical potential, E, is related to the pH as described by the Nernst equation:

$$E = {E}^{0} - 2.303 \frac{RT}{F} pH = {E}^{0} - 0.05916 pH \qquad ( 5 )$$

where E⁰ is the standard potential of the electrode, F is the Faraday's constant with a value of 96487 CEq⁻¹, R is the gas constant having a value of 8.314 JK⁻¹Eq⁻¹ and T is temperature in Kelvin. While the theoretical sensitivity of a pH electrode at room temperature is −0.59 mVpH⁻¹, iridium oxide pH electrodes show bulk pH sensitivity in the range of −59 to −90 mVpH⁻¹, depending on their preparation methods, i.e., depending on the composition of the oxide. Since there are various methods for depositing iridium oxide films on conducting substrates, such as anodization of iridium, electrodeposition, sputtering, thermal and printing methods, modifications to equation 5 are possible. Linear modifications are due to differences in the number of electrons involved in the reduction process as shown in equations 1-3; for example an electrodeposited IrOₓ.nH₂O surface might contain a combination of Ir⁴⁺ and Ir³⁺ states that are further influenced by ligands, bound water molecules in this case.

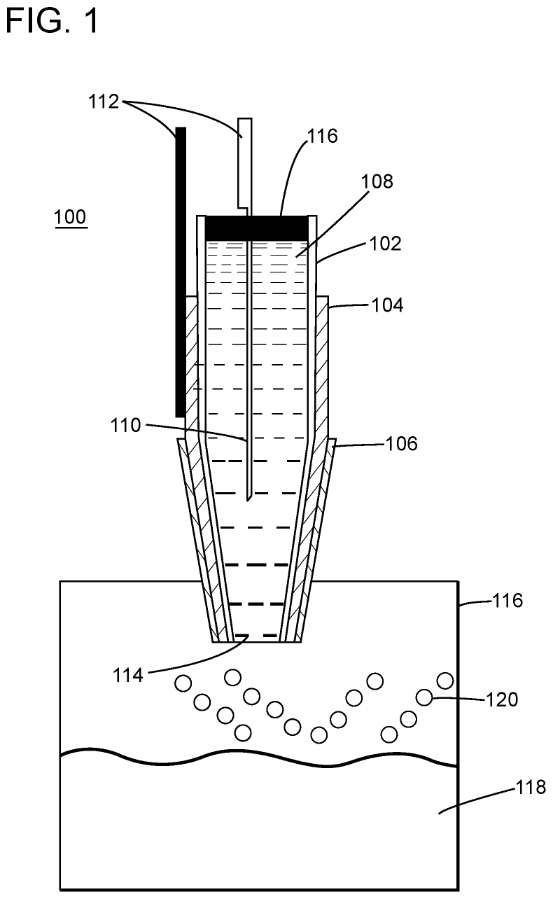

According to an embodiment illustrated in FIG. 1, a sensor 100 includes a vessel 102, which can be comprised of glass, a polymer, and/or plastic. In one embodiment, the vessel is a borosilicate glass capillary. An adhesive/conducting layer 104 is deposited on the exterior of the vessel 102 via electron-beam evaporation. Subsequently, the working electrode 106 (also referred to as a first electrode) is electrodeposited on a portion of the adhesive/conducting layer 104. In an embodiment the working electrode is formed using iridium oxide IrOₓ in the manner described in detail below. The interior of the vessel 102 includes an electrolyte 108, which according to an embodiment can be 2.33 M potassium chloride KCl and 1% agar in water. A reference electrode 110 (also referred to as a second electrode), which can be made of silver/silver chloride Ag/AgCl, is in the interior of the vessel and submerged in the electrolyte 108.

The sensor 100 operates electrochemically, which involves the following: conductive wires 112, such as copper wires, for connecting to a voltage detector (not illustrated in FIG. 1). One of the conductive wires 112 contacts the adhesive/conducting layer 104 and the other of the conductive wires 112 contacts a portion of the reference electrode 110 that protrudes outside of the vessel 102, and therefore not in direct contact with the electrolyte 108. In order to form a closed circuit, the bottom of the vessel 102 includes an opening 114 so that the electrolyte is in contact with both the working electrode 106 and the reference electrode 110. In an embodiment the width of the bottom of the vessel 102 is 100 μm. A seal 116 is formed at the top of the vessel to prevent the electrolyte 108 from draining from the interior of the vessel 102.

In FIG. 1, the bottom of sensor 100 is placed inside of a container 116, which contains liquid 118 and a gas vapor 120, which is the vapor of the liquid 118. In this arrangement, the sensor can detect whether a particular gas is present in the gas vapor 120, and thus also in liquid 118. It should be recognized that the illustration of the sensor 100 detecting the presence of a particular gas vapor 120 in a container 116 is merely exemplary and the sensor 100 can detect the presence of gas in the environment.

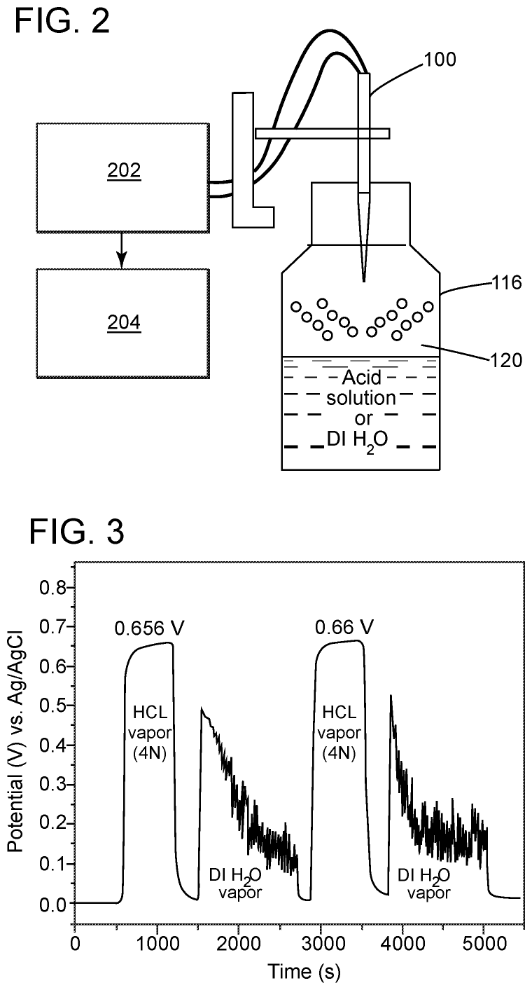

FIG. 2 illustrates a system for detecting the presence of a particular gas, acidic, basic, or neutral, according to an embodiment. The system includes sensor 100 placed inside the container 116. Note that sensor 100 does not need to be in contact with the liquid inside the container 116. To determine the presence of a particular gas, the sensor 100 needs to be in contact with the gas vapor 120 of that gas. The sensor 100 is coupled to a detector 202, which in turn is coupled to an output 204. Since the sensor 100 operates by measuring voltage, in one embodiment detector 202 is a voltage detector. Output 204 can be any type of output indicating whether or not a particular gas is present. This includes one or more lights, a display, and/or an audible output indicating presence or absence of the particular gas.

According to an embodiment, detection of a particular gas is based on the detection of a voltage level corresponding to the particular gas. As illustrated in the voltage response curve of the sensor 100 in FIG. 3, the sensor 100 produces a voltage of approximately 0.66 V when exposed to vapors from a 4 N hydrogen chloride (HCl) solution compared to smaller voltages when exposed to deionized water vapor. As also illustrated, there is very little hysteresis in the voltage when exposed to the vapors of 4 N HCl solution compared to the noisy voltage produced when exposed to the water vapor. The voltage response curve of FIG. 3 was produced with the bottom of the sensor being 7 mm above the level of the liquid, the HCl vapor at 298 K and 1 atm, and the container 116 being left open for at least 10 minutes to release any built-up gasses. FIG. 3 also shows the reliability of the sensor due to the reproducibility of the data as for example the vapors of 4 M HCl always generated the same voltage in few seconds.

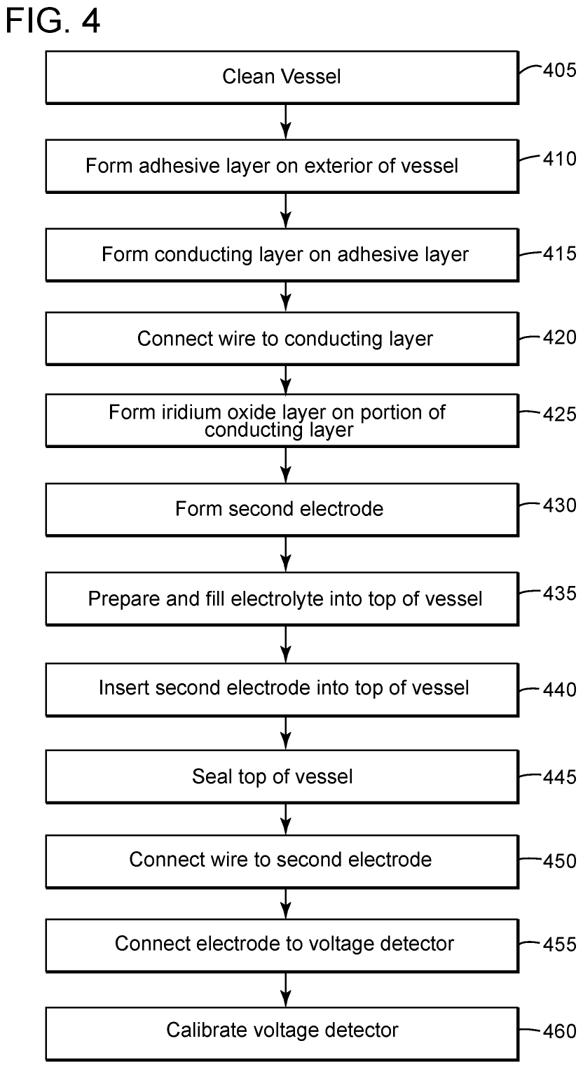

A method for manufacturing the sensor is illustrated in the flowchart of FIG. 4. Initially, the vessel 102 is cleaned (step 405). In one embodiment, the vessel 102 is cleaned by first sonicating a borosilicate capillary, such as an CG-1840-02 by Chemglass Lifesciences, with inner diameter between 0.8-1.1 mm and 0.25 mm wall thickness, successively in water and acetone for 2 minutes each, and then allowing it to dry at 80° C. for 1 hour. Next the tip of the vessel, which can be a borosilicate glass capillary, is pulled to a diameter of 50 μm using a laser micropipette puller, such as a P1000 laser micropipette puller by Sutter Instrument Co. Those skilled in the art would understand the numerical values provided in this and other embodiments are for illustration purposes only and variations of these values may also be employed.

After the vessel is formed (step 405), an adhesive layer is formed on an exterior surface of the vessel (step 410) and then a conducting layer is formed on the adhesive layer (step 415). In one embodiment, the adhesive layer is formed by sputtering 20 nm thick titanium and the conducting layer is formed by sputtering 100 nm thick gold film. The sputtering can be performed using an ESC magnetron sputtering system, which can allow spinning the vessel 102 to provide uniform deposition of the adhesive and conducting layers.

A conductive wire 112 is then connected to the conducting layer (step 420). In one embodiment, the conductive wire 112 can have a diameter of 0.1 mm and the conductive wire 112 can be connected to the conducting layer using silver and epoxy paste.

Next the working electrode 106, which in one embodiment is an iridium oxide layer, is formed on the conducting layer (step 425). In one embodiment, the iridium oxide layer electrodeposited on the conducting layer via 600 potentiodynamic cycles in the range −0.4 to +0.7 V (vs. Ag/AgCl reference electrode in 3 M KCl) at a scan rate of 1 V min⁻¹ in an aqueous 4.5 mM iridium chloride (IrCl₄) solution using an Interface-1000 potentiostat from Gamry Instruments. In one embodiment titanium- and gold-coated glass capillaries can be used as working electrodes, an Ag/AgCl (3M NaCl; E⁰=0.209 V vs. NHE) electrode can be used as the reference electrode, and a platinum (Pt) wire can be used as the counter electrode.

The iridium electrolyte can be prepared by dissolving 300 mg IrCl₄ (99.95% purity, which can be obtained from Alfa Aesar) in 200 mL of deionized water followed by addition of 2 mL 30% hydrogen peroxide (H₂O₂) solution and stirred for 10 minutes. Next 1 g of oxalic acid dihydrate (H₂O₂O₄.2H₂O) can be added and the solution can then be stirred for another 10 minutes. The pH of the solution can then be adjusted to pH=10.5 using solid potassium carbonate (K₂CO₃) pellets/powder. The resulting electrolyte can then be allowed to age for two days at room temperature (22° C.). The electrolyte, which was originally yellow, turns violet after ageing. This solution can be stored at 4° C. and used for several months with consistent results.

After forming the iridium oxide layer (step 425), the second electrode is formed (step 430). In one embodiment, which was discussed above in connection with FIG. 1, the second electrode is an Ag/AgCl wire. This wire is formed by first anodizing a clean Ag wire, which in one embodiment can have a diameter of 0.5 mm and 99.9% purity, with an applied voltage of 1.5 V using a Keithley 2400 source-meter for 15 min in 1 M KCl solution. Another Ag wire can be used as the counter electrode. The second electrode formed in this manner may have a brown coating.

The electrolyte is then prepared and filled through the top of the vessel 102 (step 435). In one embodiment, the electrolyte is a bubble-free, boiled mixture of 1% agar and 2.33 M KCl aqueous solution that is perfused into the top of the vessel 102. The second electrode is then inserted into the top of the vessel so that it is at least partially submerged in the electrolyte (step 440). The top of the vessel 102 is then sealed (step 445), which in one embodiment can be achieved using an epoxy glue. A conductive wire 112 is then connected to a portion of the second electrode that is outside of the vessel 102 (step 450). The two conductive wires 112 are then connected to a voltage detector 202 (step 455), which can then be calibrated for the particular gas that is to be detected (step 460).

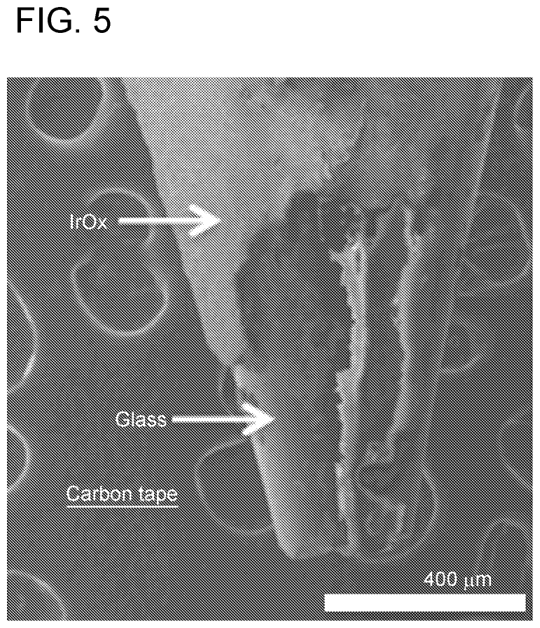

A cross-section of a sensor made according to the method above is illustrated in the scanning electron micrograph of FIG. 5. The micrograph illustrates an iridium oxide layer of approximately 25 μm being formed on the glass of the vessel 102, and with carbon tape in the background. As illustrated in the micrograph, the tip of the sensor, including the iridium oxide layer, is approximately 100 μm.

The formation of iridium oxide layer on the sensor was confirmed by x-ray diffraction, x-ray photoelectron spectroscopy, and cyclic voltammetry. Due to the relatively small size of the tip of the electrode (which in one embodiment is approximately 100 μm), it is difficult to characterize the iridium oxide layer on the tip. Accordingly, confirmation of the formation of the iridium oxide layer can be achieved by electrodepositing the iridium oxide layer on an Au/Ti/glass slide following the same process. In one embodiment, the glass slide can have an Au/Ti/glass area of 4 cm² using the method discussed above. In general, iridium oxide layers formed using the electrodeposition method described above are referred to as hydrated iridium oxide and the average oxidation state of the iridium in the iridium oxide is less than 4+, i.e., it contains both Ir³⁺ and Ir⁴⁺.

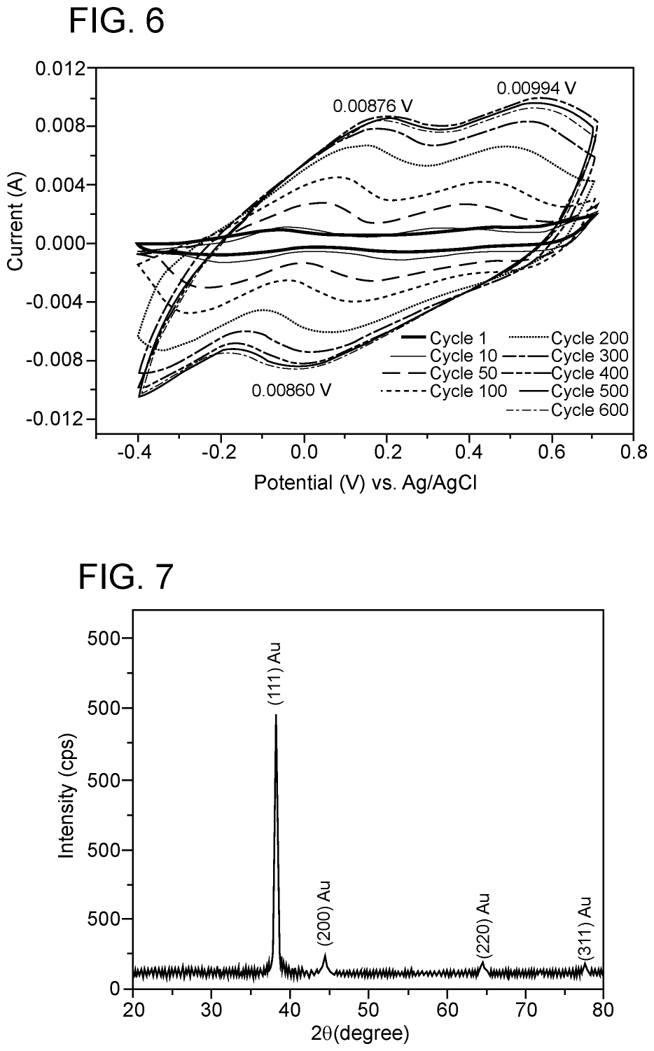

FIG. 6 illustrates cyclic voltammograms recorded during deposition of iridium oxide onto a gold surface according to the method mentioned above. As illustrated, the cyclic voltammograms recorded periodically during the electrodeposition process increase in current with the number of cycles, which confirms iridium oxide deposition.

FIG. 7 illustrates an x-ray diffraction pattern of iridium oxide film on a gold/titanium/glass slide formed according to the method above. The graph shows peaks for the gold conductive layer but no peaks for the iridium oxide, which indicates the iridium oxide crystallite size is so small (<3 nm) that they do not scatter x-rays.

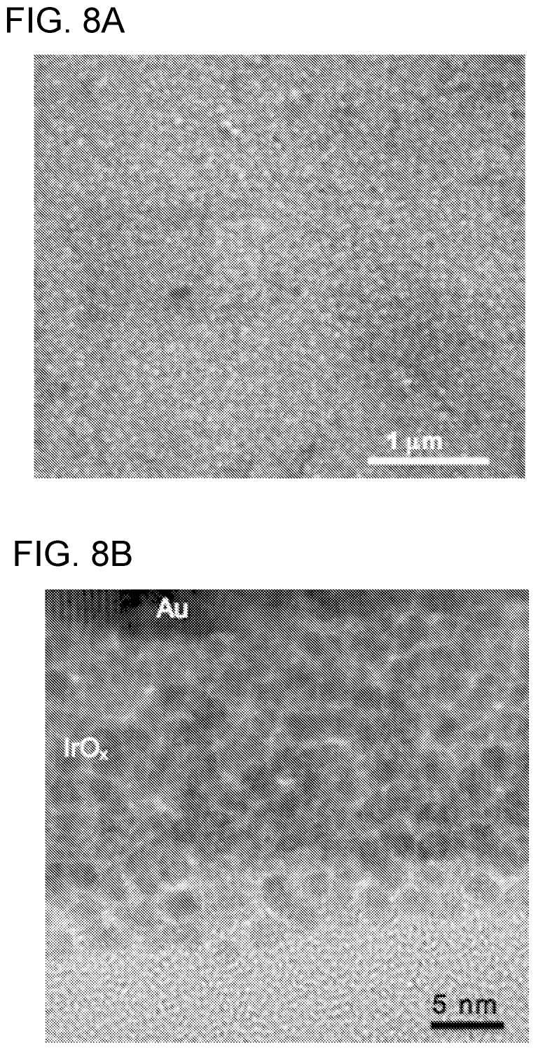

FIG. 8A illustrates a top view scanning electrode microscope (SEM) image of an iridium oxide layer formed according to the method above. This low magnification view shows the sizes of individual particles in the films were approximately 50 nm. FIG. 8B illustrates a cross-sectional transmission electron microscopic (TEM) image of an iridium oxide layer formed according to the method above. This high magnification cross-sectional TEM image illustrates the particles being mostly spherical and having a size in the range of 2.2 nm to 3.0 nm. The clear lattice fringes seen on the particles indicate the particles are crystalline. It should be understood by comparing FIGS. 8A and 8B that the bigger particles having a size of approximately 50 nm in the SEM image of FIG. 8A are made of the smaller particles in the TEM image of FIG. 8B.

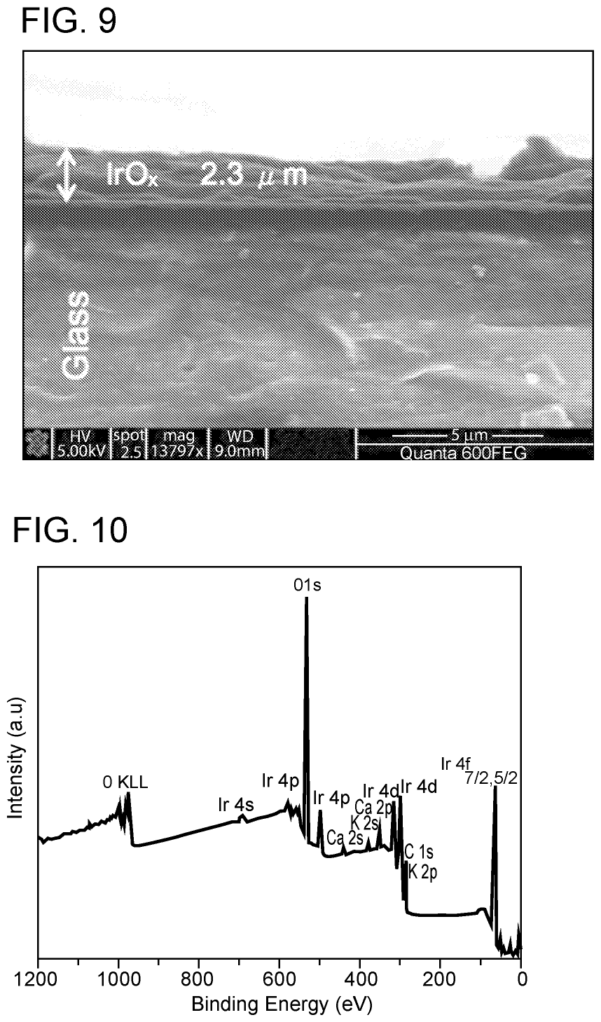

FIG. 9 illustrates a cross-sectional SEM image of an iridium oxide layer formed according to the method above. This SEM image shows the average thickness of the iridium oxide layer is approximately 2.3 μm.

FIG. 10 illustrates an x-ray photoelectron spectrum (XPS) of the gold/titanium/glass slide formed according to the method above. This shows the presence of iridium (Ir), potassium (K), oxygen (O), calcium (Ca), and carbon (C). The presence of iridium and oxygen confirms the presence of iridium oxide. Presence of elements like K, Ca and C is due to the other reagents and materials like potassium carbonate, glass slide, oxalic acid, carbonate, air-borne hydrocarbon impurities used during the fabrication process.

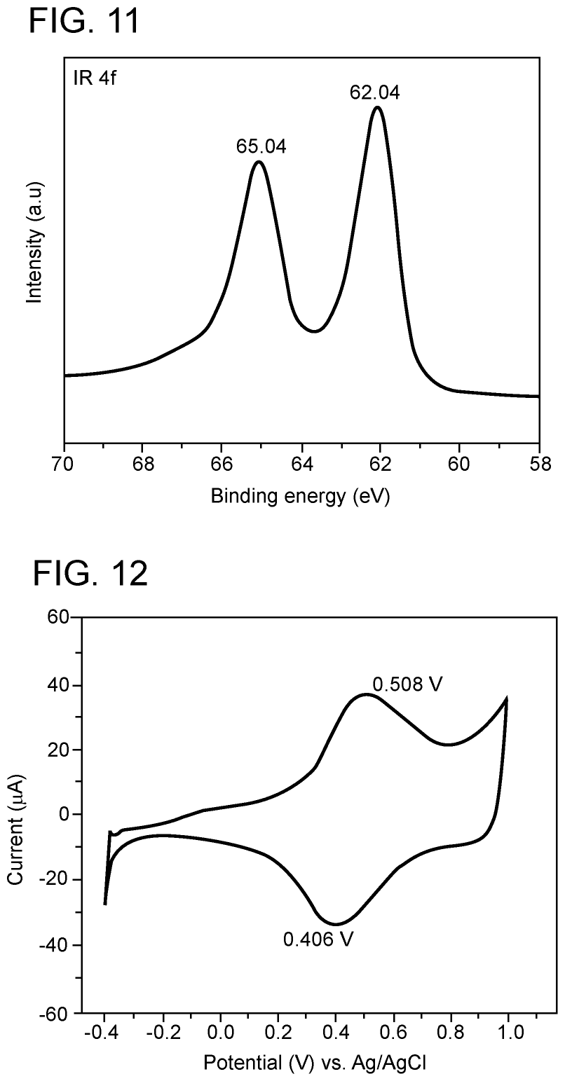

FIG. 11 illustrates an infrared 4f spectrum of an iridium oxide film formed according to the method above. The peak positions confirm the presence of Ir⁴⁺ and/or Ir³⁺, and that Ir⁽⁰⁾ is absent. Although Ir⁴⁺ and/or Ir³⁺ are not distinguishable based on the position of the peaks in the XPS, it confirms the layer is composed of iridium oxide.

FIG. 12 illustrates cyclic voltammograms of iridium oxide deposited on gold/titanium/glass slide, formed according to the method above, in 0.1 N H₂SO₄ solution at a scan rate of 10 mVs⁻¹. The shape of the cyclic voltammograms confirms the presence of iridium oxide.

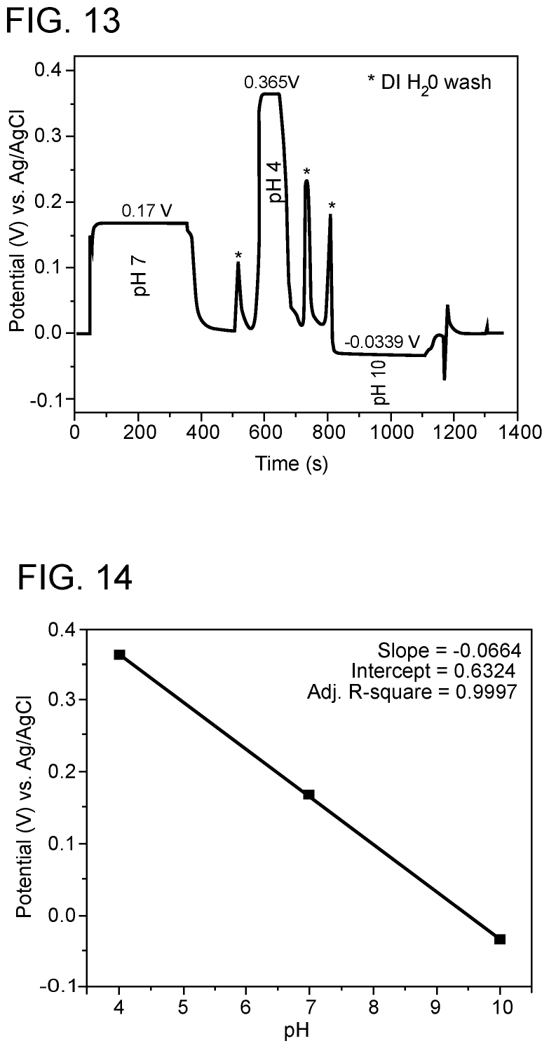

FIG. 13 illustrates an open circuit potential measured by a sensor formed using the method above in different standard pH buffers measured in series. The spikes (designated by “*”) between the responses corresponds to the washing of the pH buffers with deionized water and hence demonstrates the pH sensitivity, the ability to detect the presence of acids and/or bases with a particular pH, in bulk solutions.

FIG. 14 illustrates the calibration curve of a sensor formed according to the method above based on OCP's obtained in three standard pH buffer solutions. The fit observed with the R square value of 0.9997 demonstrates the response of the sensor in pH buffers is highly linear showing the characteristics of an ideal iridium oxide pH sensor. The sensitivity of the pH is −66.4 mVpH⁻¹ and the standard potential) (E⁰) of the sensor is 632.4 mV, which is commonly referred to a super-Nernstian behavior well known for iridium oxide electrodes.

The measurements illustrated in FIGS. 12-14 can be obtained using a 6½ digit Keithley 2100 multimeter interfaced with a Labview software. This allows collection and storage of data at a rate of 42 points-s⁻¹. The sensor can be attached to a Thorlab micrometer stage for fine movements and a millimeter stage underneath for coarse movements. The entire setup can be placed on an anti-vibration table during the measurements.

FIG. 15 illustrates a flowchart of a method of using a sensor according to an embodiment. Initially, a sensor system formed using the method above is arranged in an environment without contacting liquid (step 1505). The sensor system detects a gas using a voltage produced by the sensor (step 1510). As discussed above, the detection of gas using the sensor is based on pH. The sensor system, in particular the voltage detector 202, determines the presence of a particular gas (from the list of desired gas to be sensed) in response to the voltage produced by the sensor falling within a predetermined voltage range (step 1515). The sensor works perfectly in the potential range of −31.6 mV to 366.8 mV and hence is able to detect wide range of gases from acidic, neutral to basic. It is an advantage over the sensors which uses a discrete value for sensing gases. Thus, referring again to FIG. 13, for a neutral gas of pH7, the sensor produces a voltage of 175±15 mV.

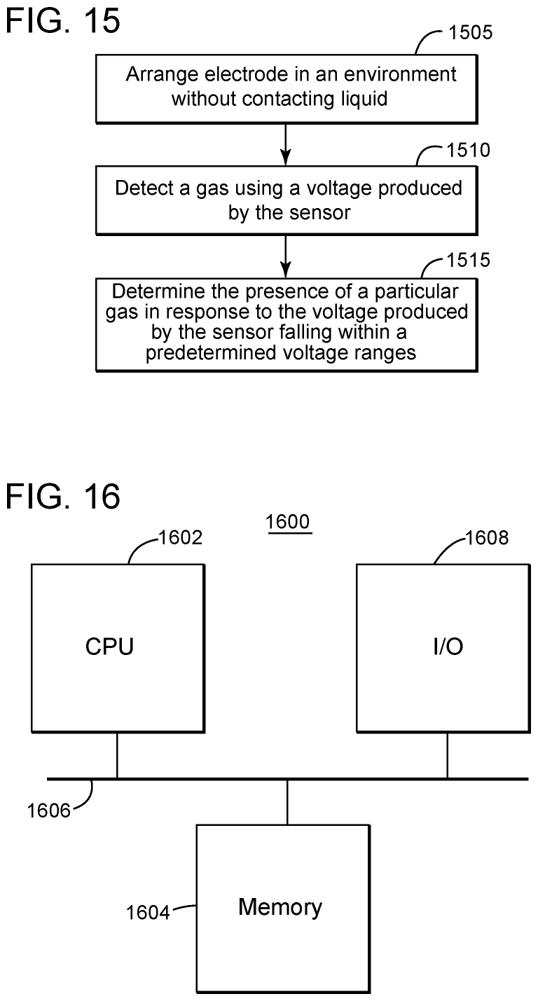

The above-discussed procedures and methods may be implemented in a computing device as illustrated in FIG. 16. Hardware, firmware, software or a combination thereof may be used to perform the various steps and operations described herein.

The computing device 1600 of FIG. 16 is an exemplary computing structure that may be used in connection with such a system, and it may include a processor 1602 and a storage device 1604 that communicate via a bus 1606. An input/output interface 1608 also communicates with the bus 1606 and allows an operator to communicate with the processor or the memory, for example, to input software instructions for operating the sensing system. The computing device 1600 may be a controller, a computer, a server, etc.

A sensor produced in the manner described above provides a number of advantages over conventional sensors. The sensor can detect the particular gas present in an ambience or in a liquid. Further, the sensor is able to directly detect the presence of a particular gas without an intervening membrane, which decreases detection time and simplifies production of the sensor. The detection time for any gas is few seconds which is significantly faster than the capacitive sensors with a detection time of 20 seconds.

The sensor has wide range of applications from emergency alarm unit to poisonous gases detection (for example hydrogen sulfide), to acidic gases detection in food and beverage industry (for example acetic acid) to quantitative detectors/meters. For example, cytology labs commonly use large amounts of acetic acid as fixative agent and workers are exposed to large amount of acetic acid vapors that are harmful (allowed 7.5 ppm). The sensor can also be used as quantitative sensor for measuring the vapor concentrations. The microscale size of the sensor facilitates its use in microbiology and also on construction sites to monitor water leakage at minor cracks. Other uses include breath monitoring, humidity control in industrial textile dryers, combustion rigs, detection of water leakage, mapping on roofs, and in-situ humidity measurements in airplane surfaces, humidity control of electronic devices, and detection of water activity in foods. The wide range of uses of the sensor is due to its high sensitivity over a wide range of pH, prompt response, reproducibility, low hysteresis, negligible temperature dependency, low cost of fabrication and maintenance, and facile fabrication.

The disclosed embodiments provide a gas detection system and apparatus and methods of making and using the system and apparatus. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A sensor system, comprising:
a vessel;
a first electrode arranged on an exterior of the vessel, wherein the first electrode comprises iridium oxide;
an adhesive layer arranged between the first electrode and the exterior of the vessel;
an electrolyte arranged within the vessel;
a second electrode in contact with the electrolyte in the vessel; and
an opening at a bottom of the vessel wherein the opening is configured to allow the electrolyte to contact the second electrode.

2. The sensor system of claim 1, further comprising:
a conducting layer arranged between the adhesive layer and the first electrode.

3. The sensor system of claim 1, further comprising:
a voltage detector coupled to the first and second electrodes, wherein the voltage detector outputs a warning when sensed voltage across the first and second electrodes exceeds predetermined limit.

4. The sensor system of claim 1, wherein the adhesive layer comprises titanium.

5. The sensor system of claim 1, wherein the conductive layer is gold.

6. The sensor system of claim 1, wherein the electrolyte comprises potassium chloride and 1% agar in water.

7. The sensor system of claim 6, wherein the potassium chloride has a molar concentration of 2.33.

8. A method for producing a sensor system, the method comprising:
depositing a conducting layer on an exterior of a vessel (102);
connecting a wire to the conducting layer;
forming an iridium oxide layer on the conducting layer using potentiodynamic cycling between a positive and negative voltage in an electrolyte containing iridium chloride, wherein the iridium oxide layer is a first electrode;
filling an interior of the vessel with an electrolyte;
inserting a second electrode into the electrolyte inside the vessel; and
sealing a top of the vessel.

9. The method of claim 8, further comprising:
forming the second electrode by anodizing a silver wire with an applied voltage of 1.5 volts vs. silver/silver chloride electrode for 15 minutes in a 1 M potassium chloride solution.

10. The method of claim 8, wherein a difference between the positive and negative electrodes are at least one volt.

11. The method of claim 8, further comprising:
forming an adhesive layer on an exterior of the vessel, wherein the conductive layer is formed on the adhesive layer.

12. The method of claim 11, wherein the adhesive layer and conducting layer are formed higher towards the top of the vessel than the iridium oxide layer.

13. The method of claim 8, wherein the vessel is a borosilicate glass capillary.

14. The method of claim 8, wherein the vessel is formed from polymer or plastic.

15. The method of claim 8, wherein the top of the vessel is sealed with an epoxy glue.

16. The method of claim 8, further comprising:
connecting a voltage detector to the sensor; and
calibrating the voltage detector for a predefined pH value.

17. A method of determining presence of a particular gas, the method comprising:
arranging a sensor in an environment, wherein the sensor comprises a first electrode comprising iridium oxide and a second electrode omprising silver/silver chloride and the sensor does not directly contact a liquid from which the gas is produced;
detecting a gas using a voltage produced by the sensor; and
determining the presence of the particular gas in response to the voltage produced by the sensor falling within a predetermined voltage range.

18. The method of claim 17, the sensor directly contacts the gas in the environment without an intervening membrane.

19. The method of claim 17, wherein the predetermined voltage range is based on a pH level of the particular gas.

20. The method of claim 17, further comprising:
outputting an indication of the presence of the particular gas.
